(19) United States
(12) Patent Application Publication
(10) Pub. No.: US 2024/0149777 A1
(43) Pub. Date: May 9, 2024

(54) ADJUSTABLE LOAD SECURING MECHANISM

(71) Applicant: Luke Fogg, Salem, NJ (US)

(72) Inventor: Luke Fogg, Salem, NJ (US)

(21) Appl. No.: 18/486,400

(22) Filed: Oct. 13, 2023

Related U.S. Application Data
(60) Provisional application No. 63/424,093, filed on Nov. 9, 2022.

(51) Int. Cl. B60P 7/15

(52) U.S. Cl. CPC B60P 7/15

(57) ABSTRACT

An adjustable load securing apparatus makes use of multiple load bars which may be secured relative to each other so as to be moved in operative proximity to loads in a tractor trailer or similar transportation vehicle. The load support members of the apparatus exert opposing force to maintain loads in a vertical position.

### CROSS-REFERENCE TO RELATED APPLICATIONS

This Application claims priority to U.S. provisional patent application No. 63/424,093, filed on Nov. 9, 2022, the entire contents of which is incorporated herein by reference.

### FIELD

This disclosure relates, generally, to securement of truck loads, and to an adjustable apparatus for securing loads within trucks or trailers and the like.

### BACKGROUND

Loads may be secured to truck beds, cabs, or trailers by strapping the loads, such as against the floor of the transportation vehicle, or by using apertures extending along the length of a cargo zone or trailer. In the case of strapping, the load may be impeded from lateral and longitudinal movement by the pressure of strapping in the vertical downward direction against the bed of the truck, and the sides of such strapping or securement likewise may prevent movement of the loads. Such strapping suffers from various drawbacks and disadvantages, such as being ill-suited for tall, vertically oriented loads, or loads with small footprints relative to their heights. In the case of apertures, hooks, or other mounts on longitudinal walls of cargo zones, again, there are drawbacks and disadvantages, such as limited configurations for load securement.

### SUMMARY

In one implementation, an adjustable load securing apparatus may be used in any suitable enclosed cargo zone, such as those in trucks, such as a trailer of a tractor-trailer combination, a so-called “box truck,” and the like. The apparatus makes use of multiple load bars which have mating portion so that the load bars can be secured relative to each other in a variety of configurations, that is, they are adjustable relative to each other, thereby forming an adjustable or reconfigurable frame within the cargo zone, adapted for different load carrying requirements, depending on the cargo and any other factors associated with trucking or load transport. Certain of the load bars have supporting members which extend outwardly from the load bars to define planar support areas. These support members may be removably attached to the load bars and are oriented vertically within the truck cargo zone. In this way, the support members may be positioned adjacent to loads being carried within the cargo zone, especially loads which extend vertically and oppose, engage, or otherwise contact opposing portions of the support members. A first set of the load bars have respective, opposite ends but also have mating portions at intermediate locations between such opposite ends.

In one suitable implementation, such mating portions at the intermediate locations are structured so as to mate with mating portions located at opposite ends of a second set of load bars.

### DRAWINGS

The disclosure may be better understood with reference to the drawings appended hereto, as follows:

FIG. 1 is a perspective, partial view of a load securing apparatus according to the present disclosure shown relative to a truck cargo zone; and

FIG. 2 is a perspective view of another implementation of a load securing apparatus of the present disclosure.

### DESCRIPTION

In one suitable implementation, an adjustable, load securing device makes use of multiple load bars configured with mating portions such that they can be adjustable relative to each other and form an adjustable load bar system. Thus, for example, in one implementation, certain bars have a series of slots into which tabs or tongues of mating bars may be inserted and secured.

One or more of the adjustable bars may have support members formed from tubular members extending to define a planar shape, such as the somewhat quadrilateral shapes shown in the drawings. The support members occupy a plane such that they can oppose loads in such plane within the truck bed. Such loads may extend vertically, perhaps moreso vertically than horizontally. As such the load securing device and its load bars and supporting members may be advantageously positioned to oppose substantially vertically oriented surfaces of such loads. In other words, instead of stacking flatter loads horizontally and tying them down, the inventive load securing device or apparatus permits such flatter loads to be stood on their relatively narrow “sides” or “ends,” and the support members and load bars oppose the vertically oriented, planar surfaces of such flat loads stacked on their ends.

So, as shown in the drawings, the support members are secured to the load bars, and the load bars are secured proximate to vertically oriented loads, such that the combination of load bars and support members engage the loads and maintain the loads in the vertical position.

As such, adjacent, horizontal positioning, rather than vertical stacking, is permitted for flatter loads, resulting in efficiency and space-saving potentials when loading the truck bed using the adjustable, load securing device or system illustrated and described herein.

It will be appreciated that the load securing device and system is not limited to use with flatter loads which have been disposed on their ends, but would likewise be useful with any configuration or grouping of loads.

The load system and its load bars may have mating ends such that the support members engage loads so that they can be secured not only transversely relative to the front of a truck, but also longitudinally, within the tractor trailer or load bay, as shown. The load bars may be secured to brackets which may be secured along inner walls of the tractor trailer or other enclosed trucking surface, such that load bars may extend across the width of the tractor trailer, but other variations are possible, including those which do not extend substantially across the tractor trailer.

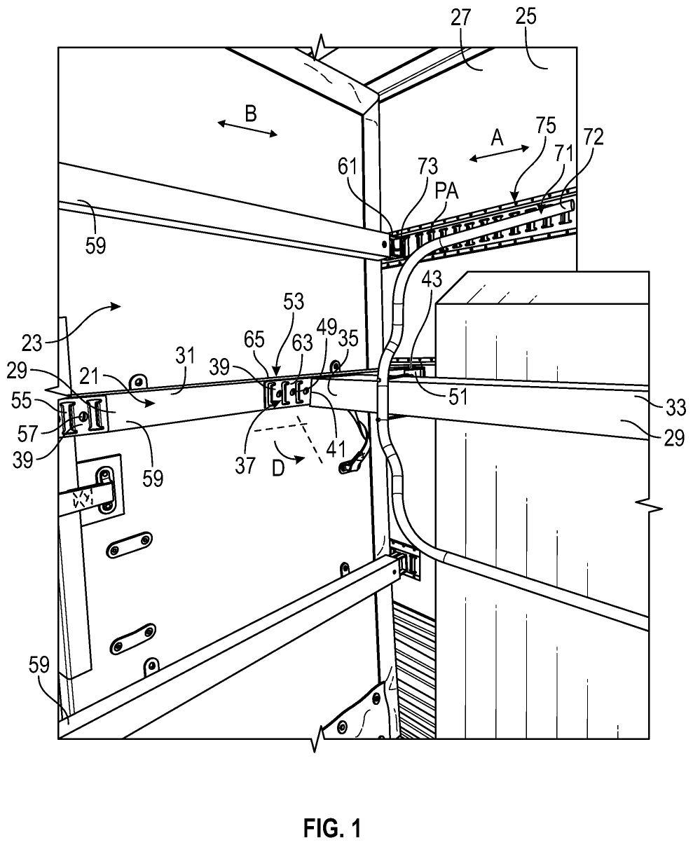

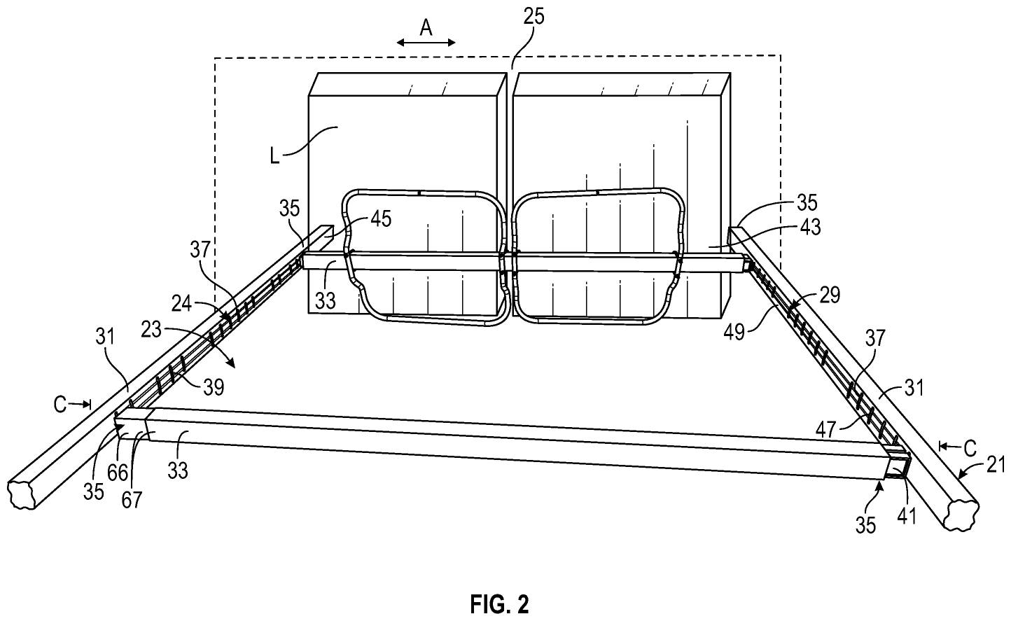

FIGS. 1 and 2 show perspective views of two possible implementations of the load securing apparatus of the present disclosure. In certain implementations, such as those shown in FIGS. 1 and 2, a load securing apparatus 21 is suitable for use in a truck cargo zone 23 of any suitable truck and cargo carrying configuration, such as typical tractor-trailer trucks, containers mountable to trailers on tractor trailer trucks, box trucks, shipping containers, moving trucks, and the like. Truck cargo zone 23 has walls 25 extending, in this case, substantially parallel, and in a longitudinal direction indicated by reference arrow A. As such, respective inner surfaces 27 are spaced from each other by a distance C measured in transverse direction B (as seen in the reference arrows).

Load securing apparatus 21 is selectively deployable and selectively adjustable, as will be appreciated by the description herein. In the illustrated implementations, a plurality of load bars 29 includes some bars which are selectively deployable in multiple locations in truck cargo zone 23 to define difference sized load carrying areas, such as load carrying area 43 in the illustration. To that end, load bars 29 include a first type of load bar or bars 31 and a second type of load bar or bars 33. Load bars 29, including first and second load bars 31 and 33, have respective, opposite ends 35 and intermediate portions 37 located between opposite ends 35.

First load bar or bars 31 have first mating portions 39 formed therein or otherwise located thereon, whereas second load bar or bars 33 have second mating portions 41 formed therein or otherwise located thereon. In the case of first mating portions 39, such first mating portions 39 are located at the intermediate portion 37 of the first load bar 31. Second mating portions 33 are located on the second load bar 33 at the opposite ends 35 thereof.

In the illustrated implementation, first load bar 31 has a length to span transverse direction C between longitudinally extending walls 25 of truck cargo zone 23 when the first load bar is removably mounted thereto. Second load bar 33 is removably connectible to intermediate portion 37 of first load bar 31, such connection being selectively accomplished by corresponding respective mating portions 39, 41. In this way, first and second load bars 31, 33 may be secured relative to each other to form an interior angle shown by reference arrow D. As shown, reference arrow D is such that first and second load bars are substantially orthogonal or perpendicular to each other, substantially meaning between plus or minus 10°, or 80 to 100°, with precise perpendicularity, of course, being at 90°.

As shown in the illustrated implementations, first and second load bars, when secured relative to each other as described above, at least partially define a perimeter 45 corresponding to a load carrying area 43.

As seen, load carrying area 43 is preferably located within the larger truck cargo zone 23, suitable for partial loads, for instance, as load carrying area 43 defines an area smaller than that bounded by cargo zone 23.

Load carrying area 43 has an interior perimeter defined by inner bar surfaces 48 of first and second load bars 31, 33.

As such, it will be appreciated from the foregoing that when a load L is placed within perimeter 45, and a portion of such load is adjacent to at least one of inner surfaces 48 of either the first or second load bars 31, 33, unintended movement of the load is inhibited in response to certain movement of the truck associated with cargo zone 23. Such truck movement, such as sudden starts, turns or other imposition of forces against inertia, may have otherwise disadvantageously caused loads carried within cargo zone 23 to shift, be damaged, or otherwise suffer undesirable consequences absent deployment of load securing apparatus 21 adjacent thereto.

As seen from the foregoing, the implementations of the disclosure allow first and second mating portions 39, 41 to be selectively and removably securable relative to each other in any number of suitable configurations, which allows the first and second load bar or bars to be deployable within any number of cargo zones for trucks or similar transportation means.

As shown in FIGS. 1 and 2, first mating portions 39 may be formed on intermediate portions 37 of relatively finite lengths, as shown in FIG. 1, but may also be formed across an intermediate portion 37 which extends substantially across the entire length of first load bar 31, as shown in FIG. 2.

In either event, first mating portions 39 may comprise multiple, spaced mounting locations 47, and the second mating portions 41 of second load bar or bars 33, in this case at the ends of second load bar 33, may be selectively mounted to a selected one of mounted locations 47 in first mating portions 47. As such, perimeter 45 enclosed by the mated first and second load bars may have its dimensions adjustable, making load carrying area 43 adjustable to suit any variety of loads to be secured thereby.

The multiple spaced locations 47 may comprise respective receiving apertures 49, and second mating portions 41 of second load bar or bars 33 may include a corresponding flange 51 at each of the opposite ends 35 of second load bars 33. As such, flange 51 is selectively receivable in a selected one of apertures 49.

According to another aspect of the disclosure, a selectively deployable, load carrying area creating first load bar 31 may be formed from existing structures, such as ordinary bars or truck portions found in connection with truck cargo zones 23. As shown in FIG. 1, a standard or otherwise available cargo zone member either integral with the cargo zone or separate therefrom, in normally transvers able mountable as shown by cargo zone member 59, such member 59 having opposite cargo zone member ends 61 and an intermediate cargo zone member portion 63 between cargo member zone ends 61. To transform such standard cargo zone member 59 into load bar 31, at least one mounting shoe 53 may be removably attached to cargo zone member 59, such as at the intermediate cargo zone member portion 63. Mounting shoe 53 has portions 57, such as fasteners, which allow it to be adjustably securable at any selected spaced location on cargo zone 59. Mounting shoe 53 has shoe portions 55 which define the receiving apertures 49 mentioned previously, suitable for receiving flanges 51, for example, of second load bars 33. By selective mounting of mounting shoe 53 to such standard structures or cargo zone members 59, first load bar 31 is able to function as one of the load bars of load securing apparatus 21 disclosed herein.

Load bars 29 may likewise be formed, in certain implementations, to have respective lengths, but to be adjustable from such respective lengths within a predetermined adjustment range 65, thereby forming load bars of adjustable length 66. It may be advantageous to have such adjustable-length load bars 66 to have fixed length of 4 ft., and a predetermined adjustment range of 8 ft., as such lengths have been found suitable for certain trucking applications and types of trucks, namely box type trailers. The adjustable length of adjustable load bars 66 may be accomplished by means of two, telescoping portions 67 securable in two respective positions, such as by pins.

Load securing apparatus 21 may include additional elements either permanently or removably secured to either first or second load bars 31, 33. In one suitable implementation, such additional elements may be in the form of support members 71 which extend outwardly relative to the longitudinal axes of load bars 29 to define planar support areas 74. Planar support areas 74 may be located so that at least portions of support members 71 lie in the same plane as inner surfaces 48 of corresponding ones of load bars 29, to increase the available points of contact on loads received in load carrying area 43. In the illustrated implementations, support members 71 may include support elements 73 extending vertically and circumferentially in the plane of all or a portion of planar support areas 74, thereby forming hoops or other planar structures adapted to contact or oppose or otherwise be adjacent to loads to be received in load carrying area or areas 43 defined by one or more first and second load bars 31, 33.

As shown in the implementation of FIG. 2, in one suitable implementation, a pair of first load bars 31 is securable spaced longitudinal locations on longitudinal walls 25 and extend across transvers distance C to orient first mating portions 39 in opposing relationship relative to each other. As such, second mating portions 41 at opposite ends 35 of second load bar 33 are matable with corresponding locations on first mating portions 39 of first load bar 31. In this manner, second load bar 33 and at least a portion of the pair of first load bars 31 define load carrying area 43.

Although the lengths and configurations of first and second load bars 31, 33 in this disclosure are exemplary only, in certain implementations, first load bar 31 may have a length of 102 inches so as to span the transverse distance of the cargo zone on certain trucks often configured with such cargo zones. Second load bar 33 has been found to have a suitable length ranging from between 48 inches and 96 inches, to correspond to applications such as holding product perpendicular to the floor. By way of further explanation, as illustrated.

As seen from the foregoing, a plurality of first or second load bars 31, 33 may be formed of varying lengths so as to comprise a kit, with lengths selected from the group consisting of 54 inches, 60 inches, 72 inches, and 84 and 96 inches. In this way, for example, if such lengths are ascribed to second load bars, second load bars are selectively deployable when first load bars are spaced from each other as a pair, such as shown in FIG. 2, and thereby form different areas for load carrying area 43.

In one suitable implementation, first load bar or bars 31 may be secured transversely in existing mounting structures on longitudinally extending walls 25 of a truck, such as E-track 75 shown in FIG. 1.

The foregoing description and related implementations are exemplary only, and are not to be construed as limitations on the disclosure, which may be varied and adjusted and still be within the spirit of such disclosure, the boundaries of such disclosure being defined by the claims appended hereto.

1. A load securing apparatus for a truck cargo zone, the cargo zone having opposing, longitudinally extending walls with respective inner, wall surfaces spaced from each other by a transverse distance, the apparatus comprising:
a plurality of load bars including first and second load bars, the first and second load bars having opposite ends and intermediate portions located between respective ones of the opposite ends;
wherein the first load bar has first mating portions and the second load bar has second mating portions;
wherein the first mating portions are located at the intermediate portion of the first load bar;
wherein the second mating portions are located at the opposite ends of the second load bar;
wherein the first load bar has a length sufficient to span the transverse distance between the longitudinally extending walls of the cargo zone;
wherein the opposite ends of the first load bar are removably mountable to respective ones of the longitudinally extending walls so as to span the transverse distance when mounted;
wherein one of the ends of the second load bar is connectable to the intermediate portion of the first load bar by respective ones of the mating portions to secure the first and second load bars relative to each other and form an interior angle relative to each other;
wherein the first and second load bars at least partially define a perimeter of a load carrying area, the load carrying area located within and smaller than the area defined by the cargo zone;
wherein the first and second load bars have inner and outer bar surfaces relative to the perimeter of the load carrying area;
whereby when the load is placed within the perimeter and adjacent to at least one of the inner bars, unintended movement of the load is inhibited in response to certain movement of the truck.

2. The apparatus of claim 1, wherein the first and second mating portions are removably securable to each other, whereby the first and second load bars are selectively deployable within the cargo zone.

3. The apparatus of claim 2,
wherein the first mating portions of the intermediate portion of the first load bar comprise multiple, spaced mounting locations; and
wherein the second mating portions of the second load bar are adapted to be selectively mounted at any one of the mounting locations, whereby the perimeter of the load carrying area is adjustable.

4. The apparatus of claim 3, wherein the multiple, spaced mounting locations of the first mating portions comprise respective receiving apertures, and wherein the second mating portions comprise a corresponding flange at each of the opposite ends of the second load bar, the flange being selectively receivable in a selected one of the receiving apertures.

5. The apparatus of claim 4, further comprising at least one mounting shoe, the mounting shoe having first shoe portions defining the receiving apertures therein and second shoe portions adjustably securable at multiple, spaced locations to the first load bar.

6. The apparatus of claim 5, for a truck cargo zone also including transversely mountable cargo zone members with opposite cargo zone member ends and an intermediate cargo zone member portion between the cargo member zone ends, the apparatus having the mounting shoe configured to be securable to the intermediate cargo zone member portion to form the first load bar of the load securing apparatus thereby.

7. The apparatus of claim 1, wherein the load bars have respective lengths, and wherein at least some of the load bars are adapted to adjust the respective lengths within a predetermined adjustment range to form a set of adjustable-length load bars.

8. The apparatus of claim 7, wherein the adjustable-length load bars have fixed lengths of 102″ and wherein the predetermined adjustment range is 12″.

9. The apparatus of claim 8, wherein the load bars of adjustable length comprise two portions telescopically received relative to each other, the two, telescoping portions securable in at least two positions.

10. The apparatus of claim 1, further comprising at least one support member removably attachable to the second load bar and extending therefrom in a plane to define a planar support area to inhibit movement of the load in response to the certain movement of the truck when the load is placed within the perimeter of the load carrying area.

11. The apparatus of claim 11, wherein the second load bar has a longitudinal axis and is oriented horizontally within the truck cargo zone, wherein the support member includes a pair of support elements and the support elements extending vertically and radially outwardly from opposite sides of the longitudinal axis of the second load bar.

12. The adjustable load securing apparatus of claim 1,
wherein the first load bar comprises a connector at each of the opposite ends to removably connect the first load bar across the transverse distance;
wherein the intermediate portion of the first load bar extends between the first load bar and the opposite ends of adjacent respective ones of the connectors and thereby has a length corresponding to the transverse distance; and
wherein the mounting locations on the first load bar extend at spaced locations over at least 80% of the intermediate portion length.

13. The load securing apparatus of claim 1, further comprising:
a pair of the first load bars securable at spaced longitudinal locations on the longitudinal walls and extending across the transverse distance;
wherein the pair of the first load bars are securable to orient the first mating portions in opposing relationship relative to each other;
wherein the second mating portions at the opposite ends of the second load bar are mateable with corresponding ones of the first mating portions of the pair of the first load bars;
whereby the second load bar and at least a portion of at least one of the first load bars define the load carrying area.

14. The apparatus of claim 1, wherein the first load bar has a length of 102 inches to span the transverse distance of the cargo zone on a standard truck.

15. The apparatus of claim 14, wherein the second load bar has a length ranging between 48 inches and 96 inches to correspond to the truck cargo zone of a box type trailer.

16. The apparatus of claim 16, further comprising a plurality of the second load bars of varying lengths selected from the group consisting of 48 inches, 60 inches, 72 inches, and 84 and 96 inches to form a kit of the second load bars selectively deployable with the first load bar to form different areas of the load carrying area.

17. The apparatus of claim 1, in which at least one of the longitudinally extending walls of the truck cargo zone has an E-track mounted thereon and extending longitudinally along the wall, the apparatus further comprising a connector formed at least one of the opposite ends of the first load bar to allow the first load bar to connect to the E-track.

18. The apparatus of claim 1, wherein the interior angle ranges between 800 and 100°.

19. The apparatus of claim 18, wherein the interior angle is 90°, whereby the first and second load bars are orthogonal to each other.

20. A method of inhibiting unintended movement of a load within a truck cargo zone, the method comprising:
deploying a plurality of load bars by securing a first load bar transversely across the truck cargo zone;
removably connecting a second load bar to the first load bar at an intermediate location thereof to define a load carrying area having smaller area then that of the truck cargo zone;
positioning the load adjacent to at least one of the first and second load bars whereby unintended movement of the load is inhibited.
